(19) United States
(12) Patent Application Publication
(10) Pub. No.: US 2014/0357354 A1
(43) Pub. Date: Dec. 4, 2014

(54) Remote Identification for Electronic Gaming Machines

(71) Applicant: WMS Gamin, Inc., Waukegan, IL (US)

(72) Inventors: Robert Gura, Romeoville, IL (US); Peter Anderson, Glenview, IL (US)

(73) Assignee: WMS Gamin, Inc., Waukegan, IL (US)

(21) Appl. No.: 14/292,436

(22) Filed: May 30, 2014

Related U.S. Application Data
(60) Provisional application No. 61/829,075, filed on May 30, 2013.

(51) Int. Cl. G07F 17/32

(52) U.S. Cl. CPC G07F 17/3241
USPC 463/29

(57) ABSTRACT

A casino management system uses unique identifiers to automatically identify individual gaming assets and to select a particular asset on a video display of a gaming floor. Information about the specific asset can be retrieved and presented on an overlay of the video display. Identification data for a plurality of assets can be used with known camera locations to automatically generate a map of asset locations on the gaming floor. A unique identifier for each EGM may be transmitted via an optical or infrared signal and received by cameras monitoring the gaming floor. The unique identifier may also be optically received via a smartphone application.

### RELATED APPLICATIONS

This application claims the benefit of U.S. Provisional Application No. 61/829,075, filed on May 30, 2013.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE DISCLOSURE

The present disclosure relates generally to gaming systems and methods, and more particularly to identification of gaming assets including electronic gaming machines on a casino floor.

### BACKGROUND OF THE DISCLOSURE

Gaming machines, such as slot machines, video poker machines, and the like, have been a cornerstone of the gaming industry for many years. Some establishments may have a relatively small number of electronic gaming machines (EGMs), in the hundreds, while larger casinos may have several thousand electronic gaming machines. Establishments with gaming machines, such as casinos, may reconfigure individual machines on a regular basis and/or may move machines to new locations in an effort to attract players and improve play times.

However, this routine reconfiguration and movement can be difficult to track, particularly on a large gaming floor. Because many gaming machines use virtually identical cabinets, accurate floor maps and manual inventories are often needed to determine actual locations and update relevant databases. Further, while security systems may be able to identify a gaming asset whose ‘candle’ is flashing, there may be no way to perform a machine or database query based simply on the visual location of the gaming asset on a display.

### SUMMARY OF THE DISCLOSURE

According to one aspect of the present disclosure, a method of providing information about a gaming asset at a console station includes presenting a live image of the gaming asset on an electronic display device, receiving, at a processor of the console station, an identifier associated with the gaming asset shown in the live image, receiving, at the processor of the console station, information regarding the gaming asset based on the identifier, and displaying, via a routine executed at the processor, at least a portion of the information on the electronic display device concurrent with the live image of the gaming asset.

According to another aspect of the present disclosure, a system for providing information about a gaming asset includes the gaming asset. The gaming asset may include a first memory storing an identifier that distinguishes the gaming asset from another gaming asset, a processor coupled to the first memory, and an emitter coupled to the processor that broadcasts a signal over the air containing the identifier responsive to the processor. The system may also include a sensor that receives the signal broadcast by the gaming asset, and a controller that receives the signal via the sensor. The controller may include a second processor, and a second memory that stores an algorithm that when executed on the second processor develops an identity of the gaming asset using the received signal.

### BRIEF DESCRIPTION OF THE DRAWINGS

FIG. 1 is a simplified and representative block diagram of an overhead view of a gaming environment;

FIG. 2 is a block diagram of the gaming environment of FIG. 1 illustrating identification of a gaming asset;

FIG. 3 is a block diagram of the gaming environment of FIG. 1 illustrating identification of another gaming asset;

FIG. 4 is a block diagram of exemplary console suitable for use in the gaming environment of FIG. 1;

FIG. 5 is an exemplary screen shot of a display of the controller of FIG. 4;

FIG. 6 is a flowchart of a method of remote identification of a gaming asset;

FIG. 7 is an exemplary electronic gaming asset in the form of an electronic gaming machine; and

FIG. 8 is a block diagram of an exemplary gaming asset suitable for use in the gaming environment of FIG. 1.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

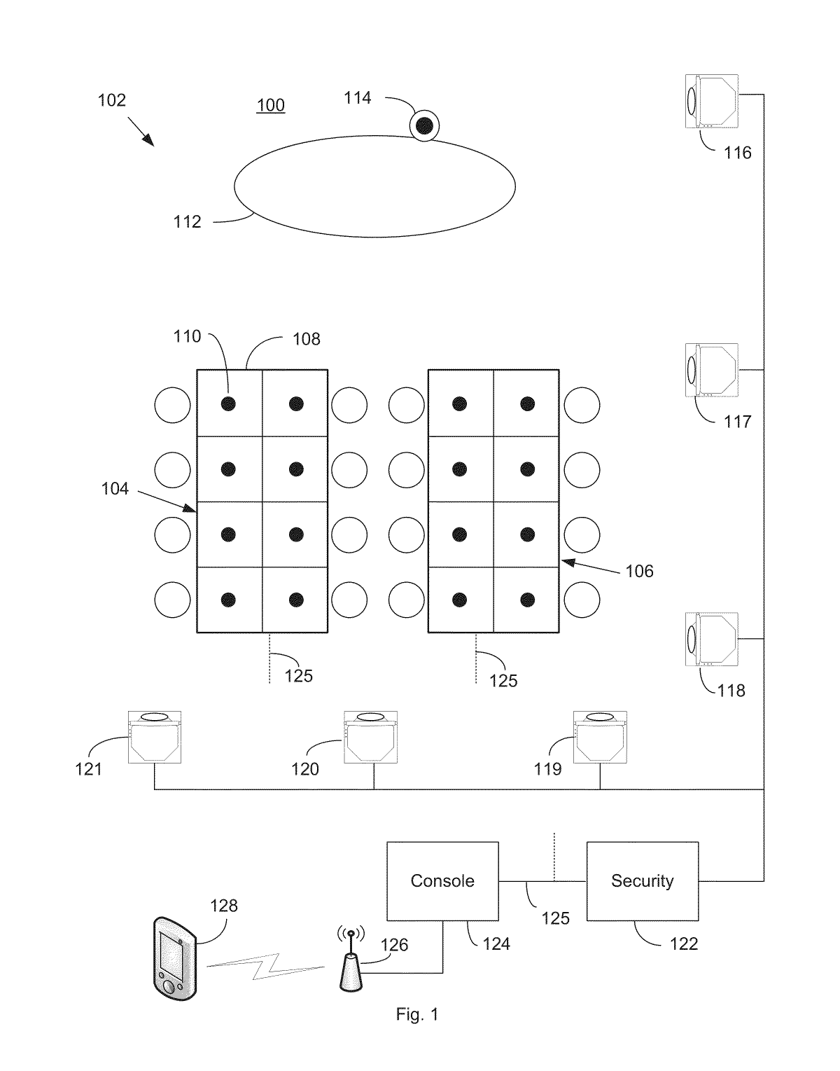

FIG. 1 is a simplified and representative overhead view of a gaming environment 100 including a gaming floor 102 and a representative security server 122 and console 124. The gaming floor 102 may include a number of gaming assets, including a first bank of electronic gaming machines 104 and a second bank of electronic gaming machines 106. Each bank of electronic gaming machines 104, 106 includes a number of individual electronic gaming machines 108. All of the electronic gaming machines in banks 104 and 106 may be linked via a data network (not depicted) used for, among other things, status queries, payout histories, alerts and alarms, software updates, accounting, etc.

Each electronic gaming machine 108 may have an emitter 110. In some embodiments, the emitter 110 may be part of a so-called ‘candle’ with one or more lights or other visual indictors. The emitter 110 may be used to indicate any of a number of conditions including, but not limited to, a malfunction, a jackpot payout, a bonus condition, or a user request. In an embodiment, the emitter 110 may include one or more infrared sources. When present, the infrared sources may be used to transmit an identification code.

The gaming floor 102 may also include one or more table games represented by table game 112, including, but not limited to, blackjack, poker, roulette, or craps. The table game 112 may also have an emitter 114 that may be the same as or similar to the emitter 110 although the exact nature of the conditions signified by activity at the emitter 114 may be different from that of emitter 110.

The gaming floor 102 may further include cameras 116-121 located around the gaming floor 102. The cameras 116-121 may be part of a security monitoring system, as depicted by way of their connection to security server 122, or may be cameras used for other purposes such as traffic analysis, etc. Alternatively, the cameras 116-121 may be dedicated to the identification and location functions described in more detail below.

The security server 122, typically located off the gaming floor 102, may be a collection point for information from the camera and other security-related sensors, such as door status, alarms, etc. The console 124 may be downstream of the security server 122 via network 125 as illustrated or may be directly connected to the cameras 116-121 or another set of cameras unrelated to security functions. The network 125 or another accessible data network may also connect the various gaming assets to the security server 122 and the console 124. The console 124 may feed data to a network 126 such as a local area network or even a wide area network. A mobile device 128 is representative of any number of smartphones, pads, tablets, PDAs, or custom devices that may be used to access the network. The mobile device 128 may be a customer device or may be used by an employee associated with the gaming environment 100 in the course of his or her duties, as discussed more below.

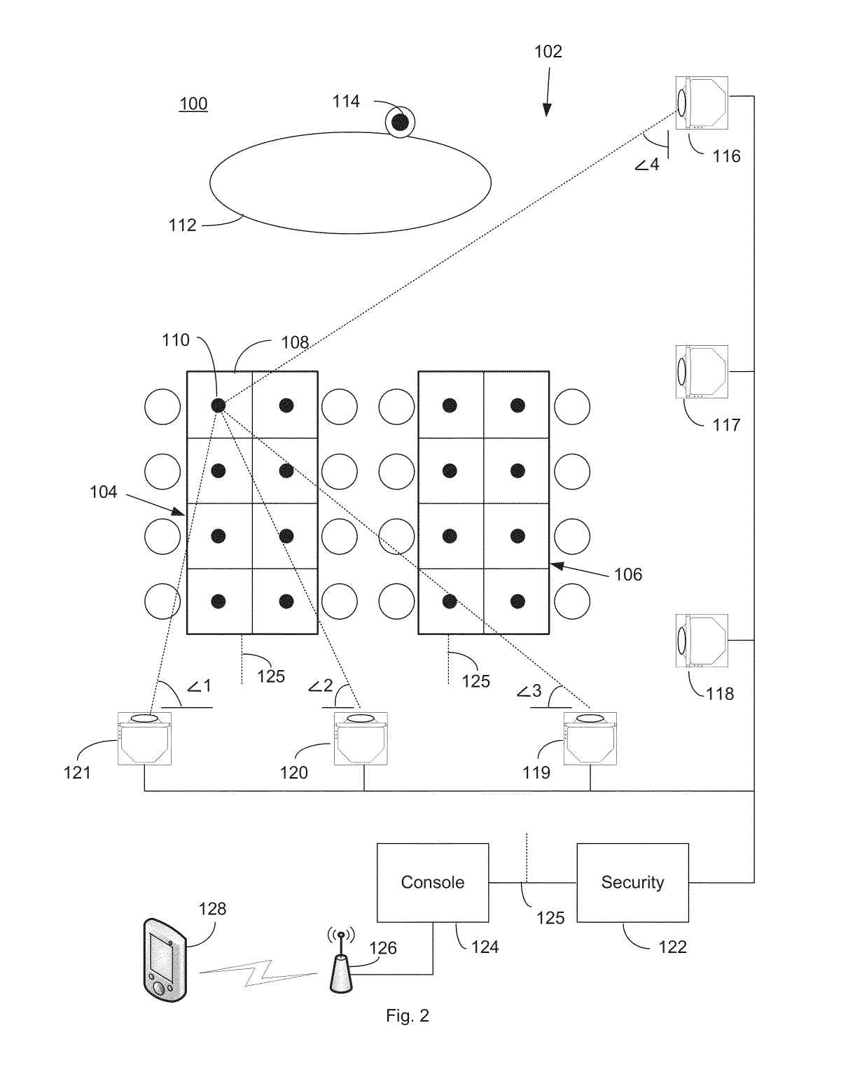

FIG. 2 is a block diagram of the gaming environment of FIG. 1, illustrating identification of a gaming asset such as electronic gaming machine 108 or table game 112. In a first example, a gaming asset, such as the electronic gaming machine 108, may indicate via its emitter 110, or candle, that a condition exists. This may be done by flashing one or more visible lights. The flashing condition may be observed at the console 124 via camera, such as camera 121. An identifier for the particular gaming asset may be coded into the signal emitted from the emitter 110 or candle. In one embodiment, a particular light on the emitter 110 may flash at a predetermined sequence. To illustrate using a simple example, one light may flash a Morse code sequence of one or more symbols, such as numbers or letters, which represents the identifier of the gaming asset.

In another embodiment, lights of different colors may flash in a combination sequence, either in a coordinated fashion or separately. For example, one color may flash a first letter code and another color may flash another letter code. In another example, the colors may flash in a particular sequence that is interpreted by the console 124 to identify the gaming asset 108. Other combinations of colors and sequences may be used in keeping with this general concept.

In yet another embodiment, the electronic gaming machine 108, via emitter 110, may use one or more infrared transmitters to transmit, for example, a pulse coded sequence. Because most digital cameras are sensitive in the infrared spectrum, many existing and most new cameras in a gaming environment 100 would be capable of capturing an infrared signal.

After identification of a particular gaming asset, such as electronic gaming machine 108, a database query may be generated to retrieve information about the gaming asset. In addition, communication with the gaming asset may be initiated to query the particular asset, in this example, electronic gaming machine 108. For example, if the game is generating a payout, the electronic gaming machine 108 may return information about the payout conditions, such as game status and payout amount. As will be discussed further below, the information received about the gaming asset may be displayed coincidentally on a display showing a live image of the gaming asset from a particular camera.

While this example for identifying and retrieving data about a gaming asset may be useful in and of itself, the system described may have additional capabilities of use to both the operators and the patrons of the gaming environment 100. As also shown in FIG. 2, the emitter 110 may broadcast a signal that is identified by multiple cameras, in this case 116, 119, 120, and 121. The console 124, or a similarly functioned device, may determine an angle of the identified gaming asset, in this example, electronic gaming machine 108, at each camera. As illustrated, angle 1 at camera 121, angle 2 at camera 120, angle 3 at camera 119, and angle 4 at camera 116 can be used with relatively simple triangulation to locate the electronic gaming machine 108 with respect to those cameras. Given that the location of the cameras 116-121 may be determined with a certain level of accuracy with respect to the gaming floor 102, the location of the electronic gaming machine 108 on the gaming floor may then be determined.

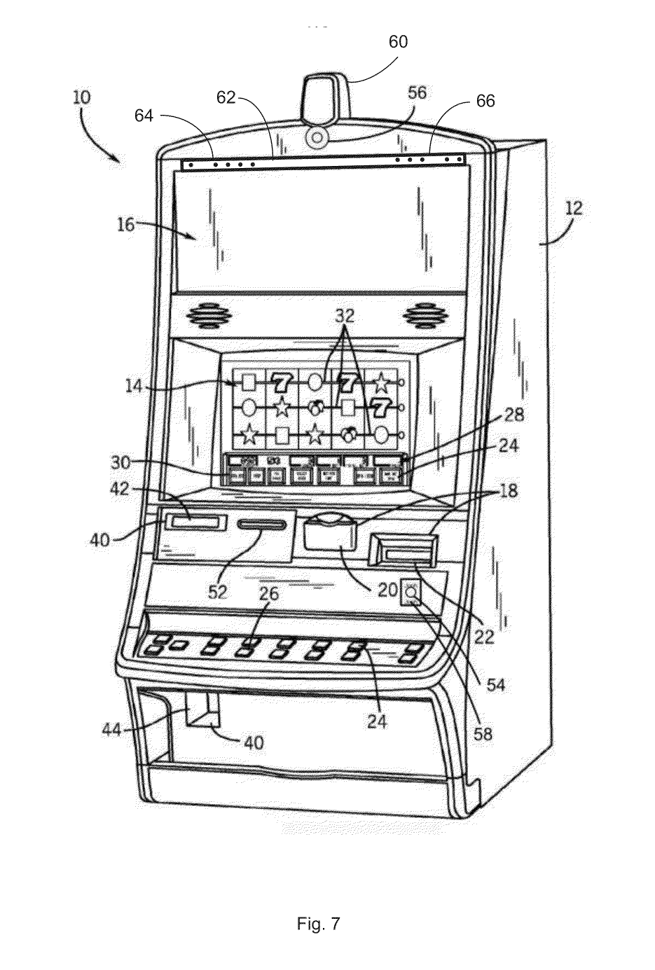

Referring briefly to FIG. 7, another embodiment may use a light bar 62 with visible or infrared lights 64 on one side of the EGM 10 and similar visible or infrared lights 66 on the other side of the EGM 10. The lights on each side may not be evenly spaced so that an analysis of an image (not depicted) from a single camera, such as camera 121 may be able to discern both the angle and the distance of the light bar 62 from the camera by characterizing the known distances between the lights on the bar 62 and the perceived distances as received at the camera. In this embodiment, rather than building a map of absolute locations of equipment, the location of one or more gaming machines may be determined relative to each other. A single camera can be used and an assumption is that at least one camera will be in the viewing range of the light bar 62 on any given gaming machine or other gaming asset. In different embodiments, the lights 64 and 66 may also be used to identify the machine using, for example, one of the techniques discussed above or another technique.

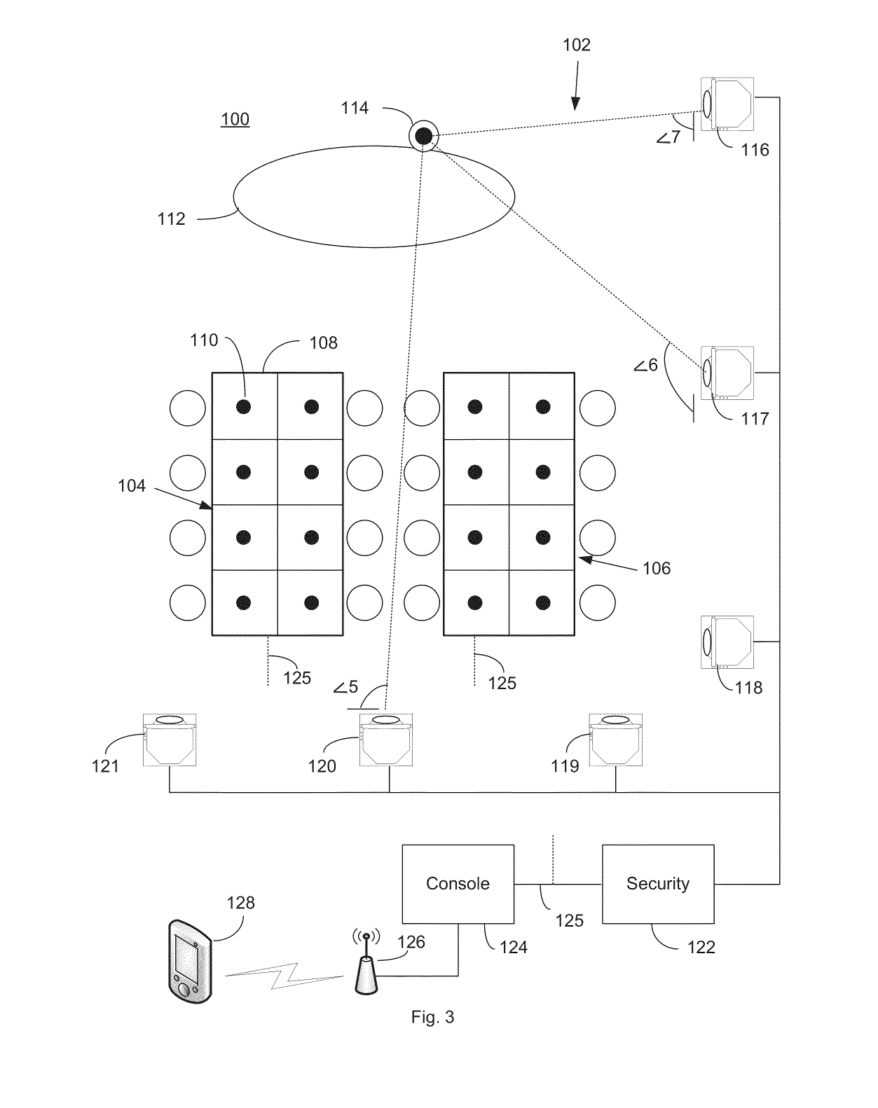

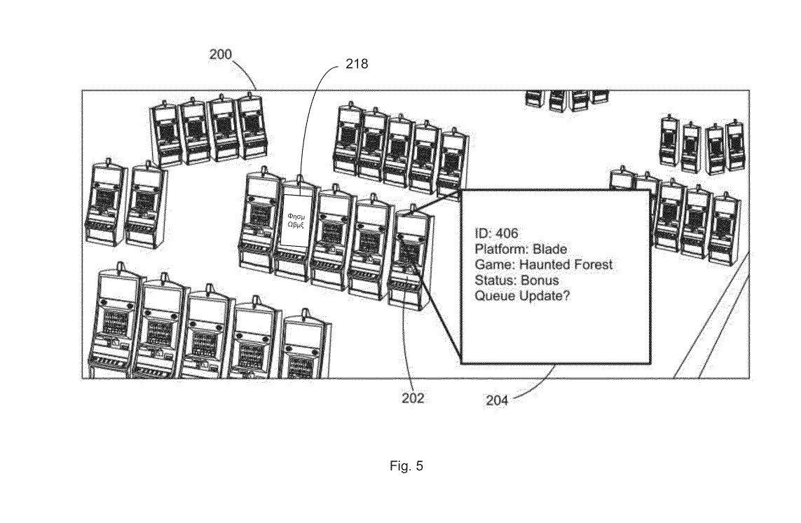

FIG. 3 illustrates another example of locating a gaming asset, in this example, the table game 112, or more particularly, the emitter 114. In this example, the signal from the emitter 114 is identified via three cameras 120, 117, and 116 having respective angle 5, angle 6 and angle 7 useable to locate the emitter 114 as described above. Once located on the gaming floor 102, the gaming asset may be identifiable from many different camera locations according to field of view information, e.g., by angle and elevation. With the locations mapped by camera, an individual gaming asset can simply be selected on the live video feed from a particular camera and related information displayed as discussed below with respect to FIG. 5.

When each gaming asset, or other gaming floor item of interest, such as automatic teller machines, etc., has been individually identified with an absolute location on the floor, a map may be automatically generated of the gaming floor 102. This map may be used strictly by the operations management of the gaming environment for inventory, asset management, marketing analysis, and other purposes. In one embodiment, a mobile device 128 used by a floor personnel may have a camera capable of identifying a gaming asset 108, 112 via its broadcast signal and retrieving in real time current information about the status.

Alternatively or in addition to this use, a mobile device 128 in the hands of gaming environment employees or patrons may have access to a map showing the location of each identified machine or other gaming asset. It would be a management decision whether to publish further information about the gaming assets either overlaid on or adjunct to the map of gaming assets, such as the game type, whether the game is available or occupied, the last time a machine had a payout, etc.

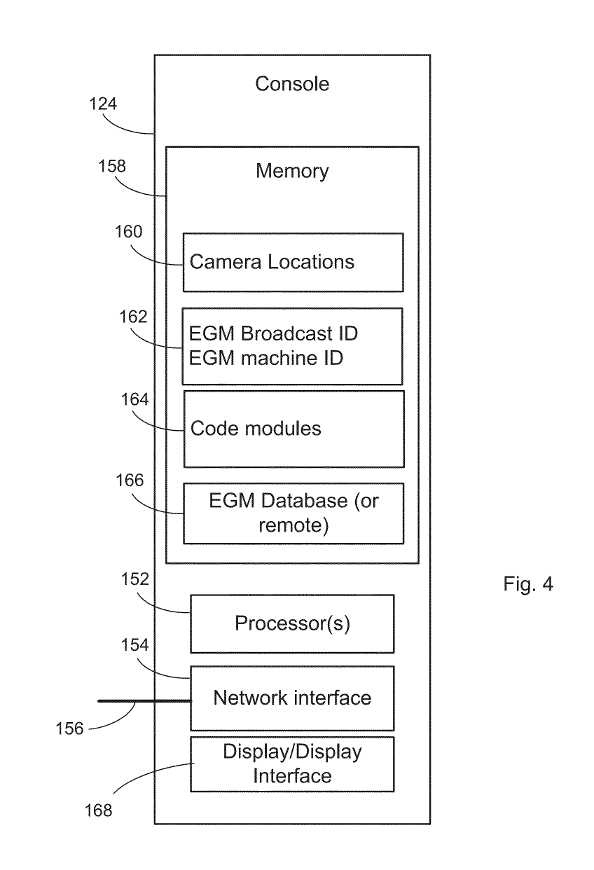

FIG. 4 illustrates an exemplary console 124. The console 124 may include a processor 152, a network interface 154 for coupling to a network 156 (the same as or similar to networks 125 and 126), and a memory 158. The memory 158 may include information on camera locations 160, gaming asset broadcast identifiers, and associated machine identifiers 162. The memory 158 may also include one or more code modules 164 such as a data retrieval routine that uses the identity of the gaming asset to retrieve information about the gaming asset and a display routine that displays the retrieved or other information about the gaming asset via a display/display interface 168.

The memory 158 may also include a gaming asset database 166. In some embodiments, the gaming asset database 166 may be located in a different machine or machines. The gaming asset database 166 may include configuration data about each gaming asset on the gaming floor 102 and may also be a source for current status of a particular gaming asset.

The console 124 may also include a display or display interface 168. The display or display interface 168 may generate, under the control of the processor 152, a graphics overlay of gaming asset information on a live video feed of the gaming floor 102, as discussed below with respect to FIG. 5.

FIG. 5 is an exemplary screen shot of a display image 200 produced at the console 124 of FIG. 4. The screen shot 200 shows a portion of an exemplary gaming floor 102 with a gaming asset 202. Information about the gaming asset 202 is displayed in an overlay window 204. The overlay window 204 may be displayed responsive to any of several conditions including, but not limited to, activation of an emitter 110 causing the gaming asset 202 to be identified at the console 124, selection of the gaming asset 202 via a cursor presented on the image 200, a trigger condition at the gaming asset, such as a user request, a payout, an error, etc.

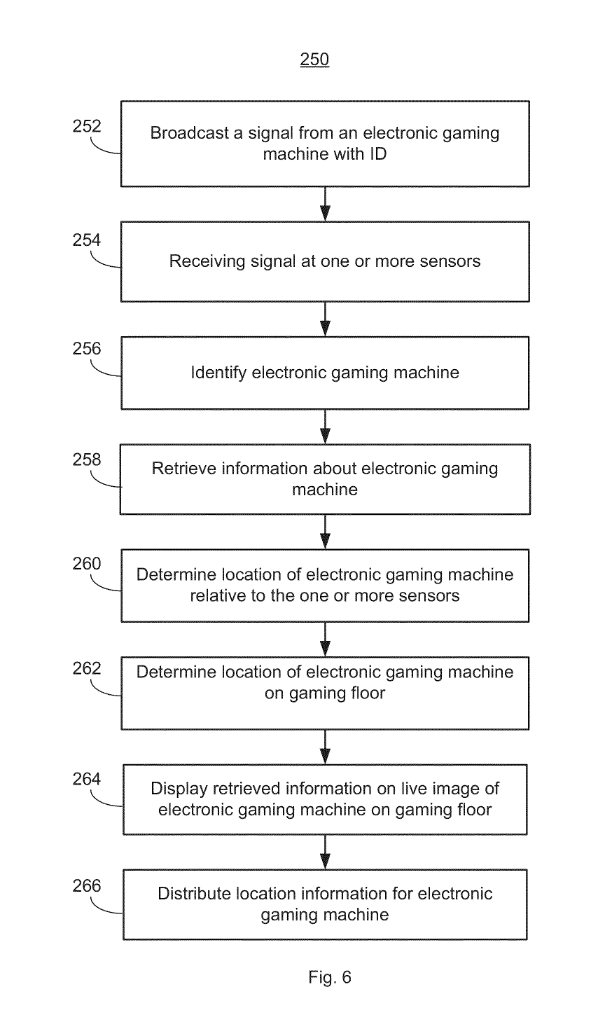

FIG. 6 is a flowchart of a method 250 of remote identification and location of a gaming asset. At block 252, a signal may be broadcast from a gaming asset, such as an electronic gaming machine 108, a table game 112, or another asset (not depicted). The signal may include an identifier that is at least unique to the gaming floor 102, but may be more globally unique, such as a serial number. The broadcast of the signal, as discussed above, may be via one or more color coded lights, via a coded infrared signal, or via another mechanism such as near-field RF, ultrasound, etc.

At block 254, the signal may be received at one or more sensors, such as cameras 116-121. To simply identifying the gaming asset, the signal may be received at only one sensor, in this example, one of the cameras 116-121 as discussed above.

At block 256, the gaming asset, such as electronic gaming machine 108, may be identified using the information in the signal. In most cases, only one sensor may be needed to identify the gaming asset because it is expected the signal would be broadcast uniformly around the gaming floor 102, but that is not required. For example, one ID could be broadcast in one direction and another ID, also related to the same gaming asset, could be broadcast in another direction. At block 258, once the gaming asset is identified, a variety of information may be retrieved from and about the particular gaming asset, such as information from a database 166 and information from the gaming asset itself via network 125.

At block 260, the signal may be received at enough additional sensors to allow automatically determining the location of the gaming asset relative to the sensors. At block 262, the absolute location of the gaming asset on the gaming floor may be developed using the known location of the sensors and the location of the gaming asset relative to the sensors. In one embodiment, each gaming asset may broadcast its identifier on a continuous basis. In this embodiment, the backend, e.g., console 124, could scan the gaming floor 102 from different cameras to find a particular gaming asset and run the location function. In another embodiment, gaming assets may broadcast their identifiers at a random interval so that individual gaming assets would be easier to identify. In yet another embodiment, a gaming asset may broadcast its identifier in response to a polling query so that only one signal is broadcast at a time. Various combinations of these or other techniques can be used, based on conditions, the number of gaming assets, the frequency of moves, etc. For example, if gaming assets are moved frequently or after a large scale move, continuous or random broadcasting may be used until the various gaming assets are located and then a polling routine may be used to confirm locations on a less frequent basis.

At block 264, the information retrieved about the gaming asset and the location of the gaming asset with respect to a camera, directly or via a mapping function to the gaming floor, are displayed. More specifically, the console 124 may display the retrieved information on a live image of the gaming floor 102 from one of the cameras 116-121, as illustrated in FIG. 5. The display of information may be in the form of a pop-up as shown or may be displayed as a semi-transparent overlay on or near the actual gaming asset. Any number of other display techniques are available for the presentation of such overlay data.

At block 266, location information about the gaming assets on the gaming floor 102 may be distributed via a data network 126. The data network 126 may be local in nature, as depicted, or may be made available more universally, such as via a casino-area network or the Internet. The information broadcast may be relatively limited, such as gaming asset locations by game type, or, as discussed above may include a richer set of data. To complement the availability of the location and/or expanded information, an application may be developed for use on mobile devices 128, such as, but not limited to smartphones and tablets. The application may allow users to query for gaming assets by type, for open machines, or for other information. The operator, in turn, may be able to analyze queries and subsequent gaming asset activity to provide a better experience for its guests or to add value to its reward program by selective access to levels of data.

FIG. 7 is a perspective view of an electronic gaming machine 10 according to an embodiment of the present disclosure. The electronic gaming machine 10 may be used in gaming establishments such as casinos. The electronic gaming machine 10 may be any type of gaming machine and may have varying structures and methods of operation. For example, the electronic gaming machine 10 may be an electromechanical gaming machine configured to play mechanical slots, or it may be an electronic gaming machine configured to play a video casino game, such as slots, keno, poker, blackjack, roulette, etc.

The electronic gaming machine 10 may include a housing 12 and may include input devices, including a value input device 18 and a player input device 24. For output, the electronic gaming machine 10 may include a primary display 14 for displaying information about the basic wagering game. The primary display 14 may also display information about a bonus wagering game and a progressive wagering game. The electronic gaming machine 10 may also include a secondary display 16 for displaying game events, game outcomes, and/or signage information. While these typical components found in the electronic gaming machine 10 are described below, it should be understood that numerous other elements may exist and may be used in any number of combinations to create various forms of an electronic gaming machine 10.

The value input device 18 may be provided in many forms, individually or in combination, and is preferably located on the front of the housing 12. The value input device 18 may receive currency and/or credits that may be inserted by a player. The value input device 18 may include a coin acceptor 20 for receiving coin currency. Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the electronic gaming machine 10.

The player input device 24 may include a plurality of push buttons 26 on a button panel for operating the electronic gaming machine 10. In addition, or alternatively, the player input device 24 may include a touch screen 28 mounted by adhesive, tape, or the like over the primary display 14 and/or secondary display 16. The touch screen 28 may include soft touch keys 30 denoted by graphics on the underlying primary display 14 and may be used to operate the electronic gaming machine 10. The touch screen 28 may provide players with an alternative method of input. A player may enable a desired function either by touching the touch screen 28 at an appropriate touch key 30 or by pressing an appropriate push button 26 on the button panel. The function may include an attendant call or help function. The touch keys 30 may be used to implement the same functions as push buttons 26. Alternatively, the push buttons 26 may provide inputs for one aspect of operating the game, while the touch keys 30 may allow for input needed for another aspect of the game. In some embodiments, a physical player sensor 56 may also be included. The physical player sensor 56 may be a camera or a biometric sensor or a motion detecting device. The physical player sensor 56 may be used to provide inputs to the game, such as images, selection motions, biometric data and other physical information. The physical player sensor 56 may also provide information to the console 124 for use in part in determining whether the electronic gaming machine 10 is in use.

The various components of the electronic gaming machine 10 may be connected directly to, or contained within, the housing 12, as seen in FIG. 7, or may be located outboard of the housing 12 and connected to the housing 12 via a variety of different wired or wireless connection methods. Thus, the electronic gaming machine 10 may include these components whether housed in the housing 12, or outboard of the housing 12 and connected remotely. As discussed above, these connections may be used to communicate status information, receive requests from the console 124 or may be used on a temporary basis to transfer update information.

The electronic gaming machine 10 may include an emitter 60, sometimes called a ‘candle’ used to visually highlight the electronic gaming machine 10 with, for example, flashing lights. As discussed above the emitter 60 may be used to transmit specific sequences of a single or multiple colored lights or may use infrared sources to broadcast identification and/or other status information. In other embodiments ultrasound, radio, or near-field transmitters may also be used.

The operation of the basic wagering game may be displayed to the player on the primary display 14. The primary display 14 may also display the bonus game associated with the basic wagering game. The primary display 14 may take the form of a cathode ray tube (CRT), a high resolution LCD, a plasma display, an LED, or any other type of display suitable for use in the electronic gaming machine 10. As shown, the primary display 14 may include the touch screen 28 overlaying the entire display (or a portion thereof) to allow players to make game-related selections. Alternatively, the primary display 14 of the electronic gaming machine 10 may include a number of mechanical reels to display the outcome in visual association with at least one payline 32. In the illustrated embodiment, the electronic gaming machine 10 is an “upright” version in which the primary display 14 is oriented vertically relative to the player. Alternatively, the gaming machine may be a “slant-top” version in which the primary display 14 may be slanted at about a thirty-degree angle toward the player of the electronic gaming machine 10.

A player may begin play of the basic wagering game by making a wager via the value input device 18 of the electronic gaming machine 10. A player may select play by using the player input device 24, via the buttons 26 or the touch screen keys 30. The basic game may include of a plurality of symbols arranged in an array, and may include at least one payline 32 that indicates one or more outcomes of the basic game. Such outcomes may be randomly selected in response to the wagering input by the player. At least one of the plurality of randomly-selected outcomes may be a start-bonus outcome, which may include any variations of symbols or symbol combinations triggering a bonus game.

In some embodiments, the electronic gaming machine 10 may also include a player information reader 52 that allows for identification of a player by reading a card 54 with player information 58 indicating his or her true identity. The player information reader 52 is shown in FIG. 7 as a card reader, but may take on many forms including a ticket reader, bar code scanner, RFID transceiver or computer readable storage medium interface. Currently, player information 58 may be generally used by casinos for rewarding certain players with complimentary services or special offers. For example, a player may be enrolled in the gaming establishment's loyalty club and may be awarded certain complimentary services as that player collects points in his or her player-tracking account. The player may insert his or her card 54 into the player information reader 52, which allows the casino's computers to register that player's wagering at the electronic gaming machine 10. The electronic gaming machine 10 may use the secondary display 16 or other dedicated player-tracking display for providing the player with information about his or her account or other player-specific information. Also, in some embodiments, the information reader 52 may be used to recall or restore game assets that the player achieved and saved during a previous game session either in the gaming establishment or on a separate computing device at a different location.

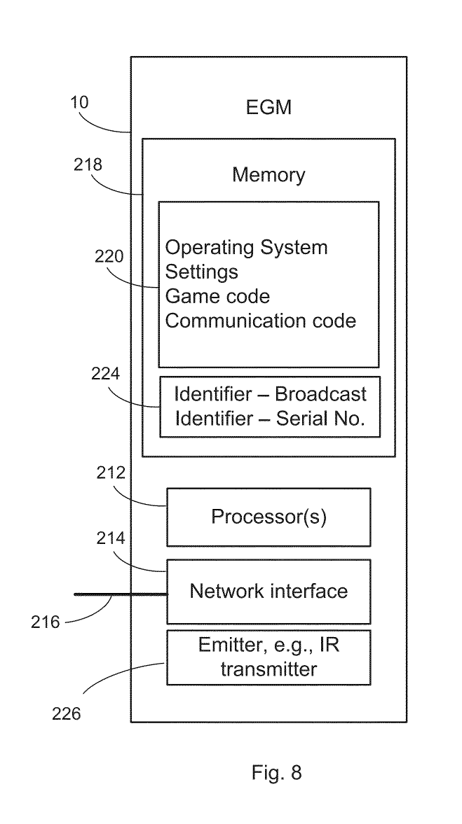

FIG. 8 is a block diagram showing more internal detail of the exemplary gaming asset 10 of FIG. 7 suitable for use in the gaming environment of FIG. 1. The electronic gaming machine 10, as an example of one kind of a gaming asset, may include a processor 212, a network interface 214 connected to a network 216, that may be the same as or similar to network 125 or 126 of FIG. 1. The electronic gaming machine 10 may also include a memory 218 with executable code and settings 220 and identifier data 224 that may include an identifier for broadcasting and serial number or other machine-specific identifier. It is contemplated that the identifier for broadcasting would be locally assigned at the gaming environment 100 and may be reassigned locally for convenience or as game floor management strategies evolve.

In summary, gaming assets can broadcast identifiers that may be used to both identify and locate gaming assets on a gaming floor 102. The identifiers can be used to retrieve information about a gaming asset that may be combined with a live video feed of a gaming floor 102 so that real time information and a live scene may be combined on one display. This may reduce demands on floor staff or may supplement security and guest convenience initiatives at a gaming environment such as a casino. Further, accurate location of gaming assets may be used by management and customers to locate gaming assets and analyze usages as well as by customers to locate favorite or sought-after games.

Each of these embodiments and obvious variations thereof is contemplated as falling within the spirit and scope of the present disclosure as defined and set forth in the following claims. Moreover, the present concepts expressly include any and all combinations and subcombinations of the preceding elements and aspects.

What is claimed is:

1. A computer-implemented method of providing information about a gaming asset in a console station having console-logic circuitry including one or more central processing units and one or more memory devices, the method comprising:
presenting a live image of the gaming asset on an electronic display device;
receiving, at the console-logic circuitry, an identifier associated with the gaming asset shown in the live image;
receiving, at the console-logic circuitry, information regarding the gaming asset based on the identifier; and
displaying, via a routine executed by the console-logic circuitry, at least a portion of the information on the electronic display device concurrent with the live image of the gaming asset.

2. The method of claim 1, further comprising broadcasting the identifier from an emitter physically attached to the gaming asset.

3. The method of claim 2, wherein broadcasting the identifier comprises broadcasting the identifier from the emitter via an infrared signal.

4. The method of claim 2, wherein receiving the identifier comprises receiving the identifier via the infrared signal broadcast from the gaming asset.

5. The method of claim 1, further comprising selecting the gaming asset via a user interface of the console station.

6. The method of claim 1, wherein the gaming asset is one of an electronic gaming machine, a table game, and an automatic teller machine.

7. A computer-implemented method of providing information about an electronic gaming machine (EGM) on a gaming floor in a system having logic circuitry including one or more central processing units and one or more memory devices, the method comprising:
broadcasting an infrared signal from the EGM;
receiving the infrared signal from the EGM at a camera; and
based on the infrared signal, determining, by the logic circuitry, at least one of an identity of the EGM or information about the EGM.

8. The method of claim 7, further comprising displaying the information about the EGM on an electronic display device showing an image of the EGM from the camera.

9. The method of claim 8, wherein the infrared signal includes an identifier associated with the EGM, and wherein determining at least one of the identity of the EGM or information about the EGM comprises retrieving the identity of the EGM using the identifier.

10. The method of claim 8, wherein displaying the information about the EGM on the electronic display device comprises displaying the information about the EGM superimposed on a live image of the gaming floor from the camera.

11. The method of claim 7, further comprising:
receiving the infrared signal at a mobile device;
associating, by the logic circuitry, the identity of the EGM via information from the infrared signal; and
using the identity of the EGM, retrieving, by the logic circuitry, information about the EGM at the mobile device via a wireless network.

12. The method of claim 11, further comprising:
publishing a physical location of the EGM; and
displaying the physical location of the EGM and the information about the EGM.

13. The method of claim 7, wherein broadcasting the infrared signal from the EGM comprises broadcasting the infrared signal responsive to a condition at the EGM.

14. The method of claim 7, wherein the infrared signal includes an identifier that is unique among a plurality identifiers of electronic gaming machines on the gaming floor.

15. A system for providing information about a gaming asset, the system comprising:
the gaming asset including:
a first memory storing an identifier that distinguishes the gaming asset from another gaming asset;
a processor coupled to the first memory; and
an emitter coupled to the processor that broadcasts a signal over the air containing the identifier responsive to the processor;
a sensor that receives the signal broadcast by the gaming asset; and
a controller that receives the signal via the sensor, the controller including:
a second processor; and
a second memory that stores an algorithm that when executed on the second processor develops an identity of the gaming asset using the received signal.

16. The system of claim 15, wherein the controller further comprises a data retrieval routine stored in the second memory that when executed retrieves information about the gaming asset using the identity of the gaming asset.

17. The system of claim 16, wherein the sensor is a camera.

18. The system of claim 17, wherein the controller further comprises a display routine that displays the information about the gaming asset concurrent with a live image of the gaming asset received via the camera.

19. The system of claim 15, further comprising a mobile device running a mobile application that receives the signal containing the identifier and displays the identity of the gaming asset via the mobile application.

20. The system of claim 15, wherein the emitter of the gaming asset is located in a candle structure located at a top of the gaming asset.
